(19) United States
(12) Patent Application Publication
(10) Pub. No.: US 2024/0100725 A1
(43) Pub. Date: Mar. 28, 2024

(54) FADE CLIPPERS ATTACHMENT APPARATUS

(71) Applicant: Joe Jones, III, Tulsa, OK (US)

(72) Inventor: Joe Jones, III, Tulsa, OK (US)

(21) Appl. No.: 17/952,222

(22) Filed: Sep. 24, 2022

(51) Int. Cl. B26B 19/20; B26B 19/38

(52) U.S. Cl. CPC B26B 19/20; B26B 19/3813

(57) ABSTRACT

The present subject matter is meant to help new hair stylists and barbers to cut hair in a specific manner. Furthermore, the subject matter is more specifically directed towards facilitating a fade haircut. This device allows for the cutting of a fade haircut without fade lines by means of a specially designed curve.

### BACKGROUND

### Technical Field

The present subject matter generally relates to an attachment apparatus meant for hair clippers to assist novice hair stylist in cutting a fade hairstyle.

### Description of the Related Art

There are many products that assist barbers and hair stylists in their craft. However, most of them are suited to handle a variety of different haircuts. Whereas the present subject matter is designed to produce a single style of haircut that is difficult for new hair stylists to perfect.

Barbers tend to use several clippers that are adjustable by opening and closing the lever by using a flicking motion. This process is difficult for the average barber and creates fade lines in the hair.

### SUMMARY

The present subject matter combines a curve on the back of the clippers so as to help facilitate the gradual removal of hair. With the attached curve on the back of the clippers the user performs an upward motion to produce a perfect fade. What makes this different from other devices is that it doesn't rely on different lengths of combs or blades to create the hair cutting effect. It relies on the shape of the curve that is affixed to the backside of the clippers.

Having this design allows a novice hairdresser to produce the perfect fade while saving time and energy. This is accomplished by eliminating the task of having to erase fade lines.

Most barbers have trouble erasing fade lines while others are never able to perfect the style. However, the curve of the attachment on the clippers mitigates this issue.

In one embodiment where a 3.175 mm blade (5) is used, the slope of the curved attachment (10) is defined by the following formula:

$$\\ y = 2.913008 \cdot {e}^{( - \frac{{( x - 12.08215 )}^{2}}{( 1 \cdot {5.962593}^{( 2 )} )} )}$$

In one embodiment where a 6.35 mm blade is used, the slope of the curved attachment is defined by the following formula:

$$\\ y = 3.479259 \cdot {e}^{( - \frac{{( x - 12.04765 )}^{2}}{( 1.5 \cdot {5.3395801}^{( 2 )} )} )}$$

In another embodiment where a 12.7 mm blade is used, the slope of the curved attachment is defined by the following formula:

$$\\ y = 7.30206 \cdot {e}^{( - \frac{{( x - 12.08164 )}^{2}}{( 1 \cdot {5.953877}^{( 2 )} )} )}$$

While the overall horizontal run until the maxima of the slope remains at a constant 12.7 mm, the overall curvature of the slope can vary. It is the overall height of each one of the curves that allows for a smooth upward motion while cutting hair that prevents the existence of fade lines.

It should be noted that all lengths are calculated in millimeters.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 shows a top perspective view of the fade clippers attachment apparatus.

FIG. 2 shows a side view of the fade clippers attachment apparatus.

FIG. 3 shows the three curves of the fade clippers attachment in relation to each other. All lengths are calculated in millimeters.

FIG. 4 shows the curve of the fade clippers attachment apparatus when the 3.175 mm blade is used.

FIG. 5 shows the curve of the fade clippers attachment apparatus when the 6.35 mm blade is used.

FIG. 6 shows the curve of the fade clippers attachment apparatus when the 12.7 mm blade is used.

### DETAILED DESCRIPTION

### Overview

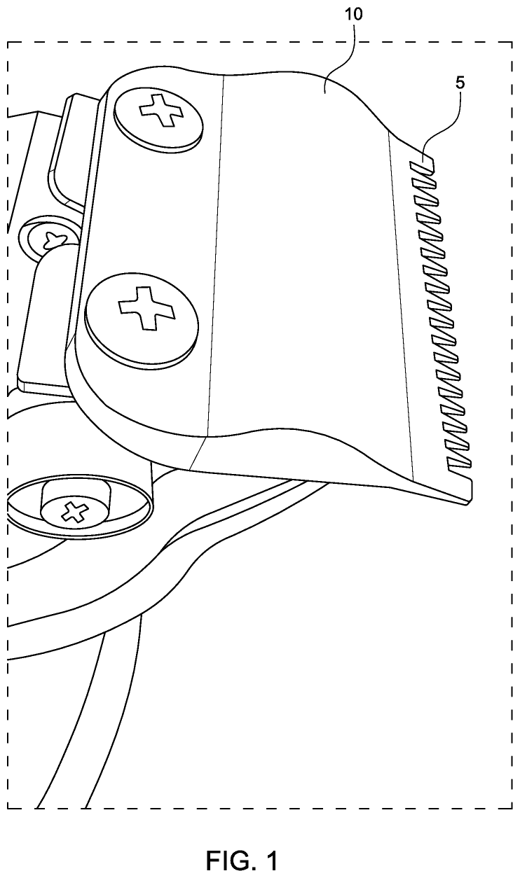

FIG. 1 shows the curve of the fade clippers apparatus to create the ideal angle to avoid creating fade lines from a top perspective. FIG. 1 shows the clippers with the 3.175 mm blade attachment which connects to the curve defined by the corresponding curve.

$$\\ y = 2.913008 \cdot {e}^{( - \frac{{( x - 12.08215 )}^{2}}{( 1 \cdot {5.962593}^{( 2 )} )} )}$$

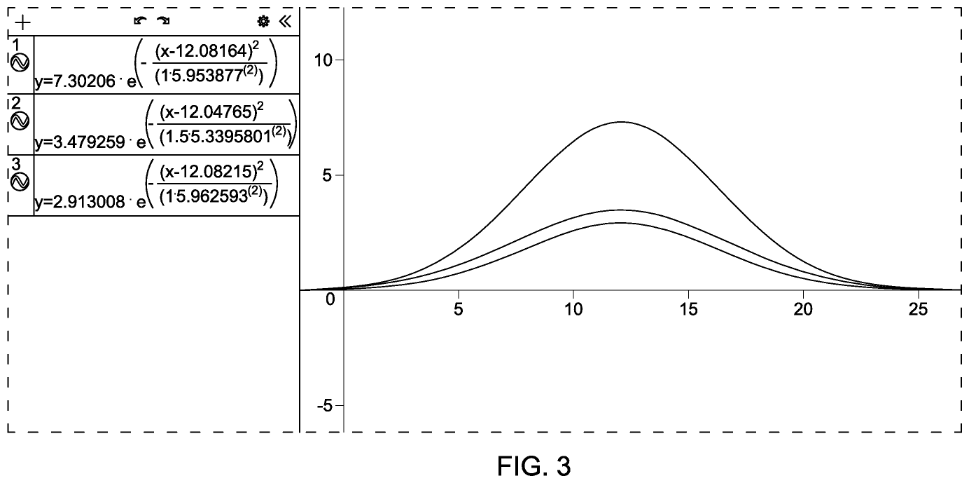

Additional figures showing the 6.35 mm fade clippers blade attachment were deemed to be redundant due to not materially altering the fundamental understanding of the subject matter. The only difference between the 3.175 mm attachment and the 6.35 mm attachment is the length of the blade and the increased steepness of the curve. These differences are illustrated by FIG. 3 and the corresponding formulae.

Additional figures showing the 12.7 mm fade clippers blade attachment were deemed to be redundant due to not materially altering the fundamental understanding of the subject matter. The only difference between the 3.175 mm attachment and the 12.7 mm attachment is the length of the blade and the increased steepness of the curve. These differences are illustrated by FIG. 3 and the corresponding formulae.

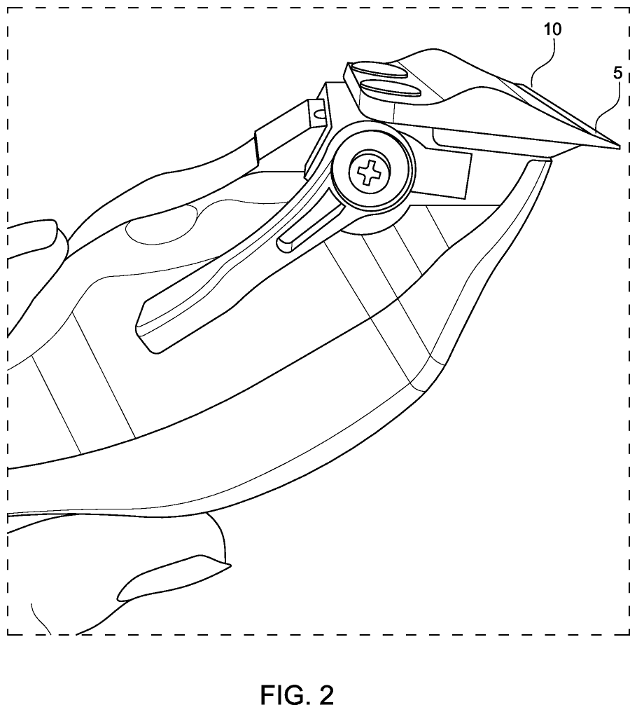

FIG. 2 shows a side view of the slope attached to the clippers to create the ideal angle to avoid creating fade lines. FIG. 2 shows the clippers with the 3.175 mm blade attachment which connects to the curve defined by the corresponding curve.

$$\\ y = 2.913008 \cdot {e}^{( - \frac{{( x - 12.08215 )}^{2}}{( 1 \cdot {5.962593}^{( 2 )} )} )}$$

Additional figures showing the 6.35 mm fade clippers blade attachment were deemed to be redundant due to not materially altering the fundamental understanding of the subject matter. The only difference between the 3.175 mm attachment and the 6.35 mm attachment is the length of the blade and the increased steepness of the curve. These differences are illustrated by FIG. 3 and the corresponding formulae.

Additional figures showing the 12.7 mm fade clippers blade attachment were deemed to be redundant due to not materially altering the fundamental understanding of the subject matter. The only difference between the 3.175 mm attachment and the 12.7 mm attachment is the length of the blade and the increased steepness of the curve. These differences are illustrated by FIG. 3 and the corresponding formulae.

FIG. 3 shows the three curves of the fade clippers attachment in relation to each other. All lengths are calculated in millimeters. FIG. 3 further illustrates how the overall horizontal run of the curves do not change from the 3.175 mm, 6.35 mm, and 12.7 mm attachments. FIG. 3 also illustrates how the maxima of the curve always occurs at the 12.7 mm mark. Furthermore, FIG. 3 illustrates the differing curvatures between the fade clippers blade attachments.

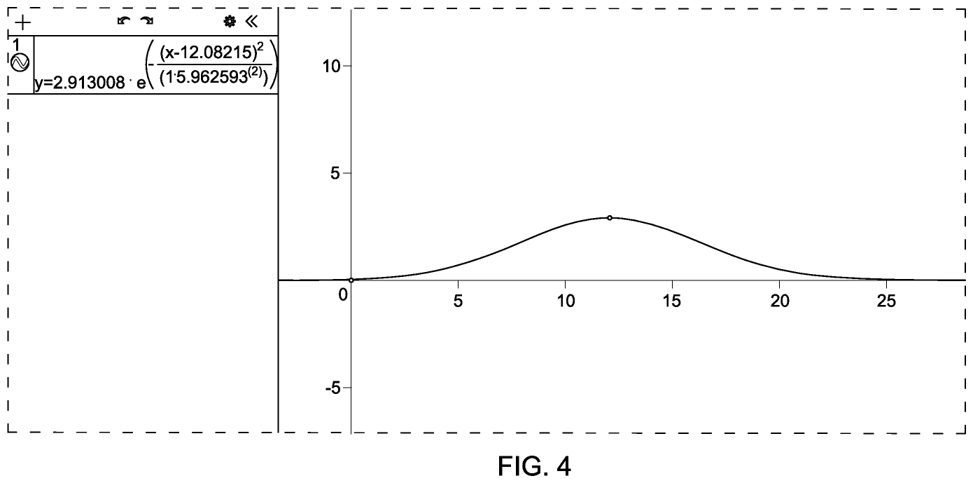

FIG. 4 shows the curve of the fade clippers attachment apparatus in isolation when the 3.175 mm blade is used.

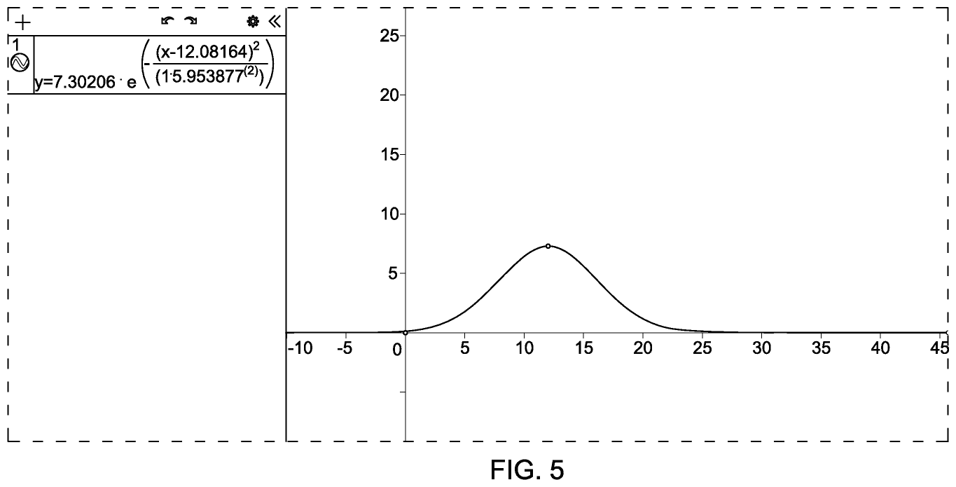

FIG. 5 shows the curve of the fade clippers attachment apparatus in isolation when the 6.35 mm blade is used.

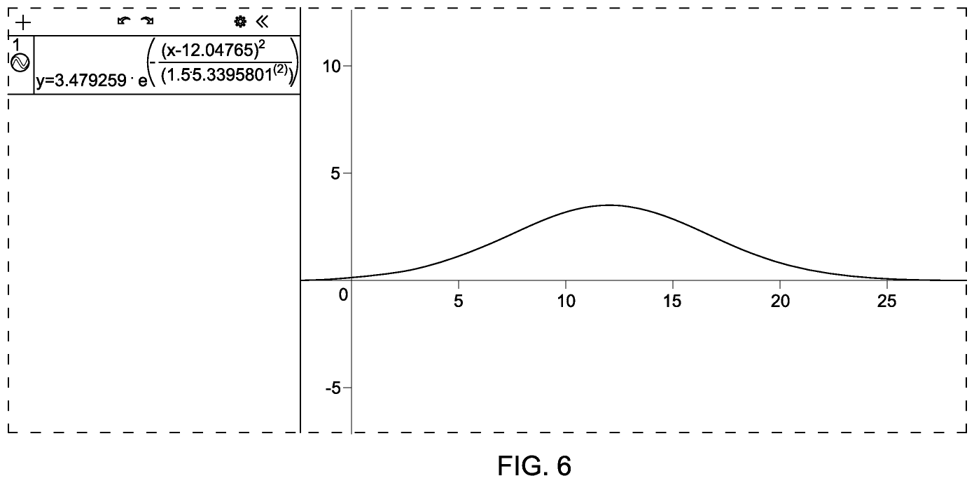

FIG. 6 shows the curve of the fade clippers attachment apparatus in isolation when the 12.7 mm blade is used.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection.

While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments of the disclosure are also contemplated. There are also embodiments of the disclosure in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A fade clippers attachment apparatus, comprising of:
a. A curve of the fade clippers apparatus to facilitate the cutting a fade haircut;
b. Mechanized clippers;
c. An internal motor to activate the clippers; and
d. A power source that operates the internal motor.

2. The fade clippers attachment apparatus of claim 1, wherein the curve of the fade clippers apparatus is affixed on the backside of the clippers.

3. The fade clippers attachment apparatus of claim 1, wherein a 3.175 mm blade is used and the slope of the curve is defined by FIG. 3 and FIG. 4.

4. The fade clippers apparatus of claim 1, wherein a 6.35 mm blade is used and the slope of the curve is defined by FIG. 3 and FIG. 6.

5. The fade clippers apparatus of claim 1, wherein a 12.7 mm blade is used and the slope of the curve is defined by FIG. 3 and FIG. 5.
